(19) United States
(12) Patent Application Publication
(10) Pub. No.: US 2019/0130417 A1
(43) Pub. Date: May 2, 2019

(54) SYSTEMS AND METHODS TO ESTABLISH DIGITAL CHAIN OF CUSTODY

(71) Applicant: Amazon Technologies, Inc., Seattle, WA (US)

(72) Inventors: William James Watt, Marblehead, MA (US); James Li-Chung Chen, Kirkland, WA (US); Christopher Angelo Rocca, Andover, MA (US)

(21) Appl. No.: 15/796,038

(22) Filed: Oct. 27, 2017

(51) Int. Cl. G06Q 30/00; G06Q 10/08

(52) U.S. Cl. CPC G06Q 30/018; G06F 17/30823; G06Q 10/083

(57) ABSTRACT

Systems and methods to maintain digital chain of custody of containers and products loaded therein are described. A container may be verified, and products to be loaded into the container may be identified. Video data may be captured throughout the loading process, and the video data, together with product information, may be combined to generate a digital container model. Further, a monitoring device may be included within the container to gather data during shipment. During shipment, the digital container model may be provided to and reviewed by a recipient of the container. Upon arrival of the container, monitoring data of the monitoring device may also be reviewed by the recipient. Based on reviews of the digital container model and the monitoring data, digital chain of custody may be established and maintained for all or a portion of the products in the container from loading to arrival.

### BACKGROUND

International and cross-border shipping of products continues to increase with the globalization of industries and markets. Generally, products that are received at borders are reviewed and inspected by customs authorities to ensure compliance with applicable regulations. However, there is high variability in shipping times and customs inspection delays, such that the total times for international shipping and inspection of products may range from a few days to a week, up to and exceeding a few weeks to a few months. Accordingly, there is a need for improved systems and methods to ensure compliance with applicable customs regulations, while also reducing the high variability associated with international shipping and customs inspections.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a flow diagram illustrating an example digital chain of custody process, according to an implementation.

FIG. 2 is a schematic diagram of an example container preparation system, according to an implementation.

FIG. 3 is a schematic diagram of an example product identification system, according to an implementation.

FIG. 4 is a schematic diagram of an example digital container model generation system, according to an implementation.

FIG. 5 is a schematic diagram of an example transport route, according to an implementation.

FIG. 6 is a flow diagram illustrating an example container preparation process, according to an implementation.

FIG. 7 is a flow diagram illustrating an example digital container model generation process, according to an implementation.

FIG. 8 is a flow diagram illustrating an example digital container model review process, according to an implementation.

FIG. 9 is a flow diagram illustrating an example container inspection process, according to an implementation.

FIG. 10 is a block diagram illustrating various components of a digital chain of custody controller, according to an implementation.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Systems and methods to establish and maintain digital chain of custody of products beginning from loading, continuing throughout shipment, and ending at arrival at a destination, are described herein. The products may comprise any type of products, items, or objects, and may be consolidated in pallets, cases, bundles, or other groups. In addition, the products may be loaded into a container, e.g., an intermodal freight or shipping container, and shipped internationally by air, sea, and/or land.

The digital chain of custody may be established by first verifying dimensions and contents of a container. For example, a container may be scanned by various devices to ensure that the dimensions match expected dimensions and to verify that the container is empty. In addition, a container monitor device that includes various sensors may be affixed within the container, e.g., near an opening of the container. Then, products to be loaded into the container may be identified using various devices. The identification of the products may include information related to contents, dimensions, weights, and other information.

As the identified products are loaded into the verified empty container, video and/or images of the loading process may be captured using various devices. The video and/or images of the loading process may capture images of products as they are loaded into the container, locations of products within the container, agents or machines that perform the loading, and other aspects of the loading process. Then, a digital container model may be generated that includes the video and/or images of the loading process, as well as information related to the verified empty container, the identified products, the identified agents or machines, and other aspects related to the container, products, agents, machines, and/or the loading process. Prior to closing and sealing the container for shipping, the container monitor device may be activated.

While the loaded and sealed container is in transit to a recipient, the digital container model may be sent to the recipient, e.g., a customs authority or other entity. Thus, the recipient may receive and analyze the digital container model prior to arrival of the container in order to identify any exceptions, e.g., model exceptions, that may require inspection upon arrival. Further, while in transit to the recipient, the container monitor device may continuously and/or periodically monitor the interior of the container for any unexpected events, e.g., unexpected motions, environment changes, and/or breaches of the container.

Upon arrival of the container at a location associated with the recipient, the recipient may receive and analyze data from the container monitor device in order to identify whether any exceptions, e.g., transit exceptions, occurred during transit. Based at least in part on any model exceptions identified from an analysis of the digital container model, and based at least in part on any transit exceptions identified from an analysis of the data from the container monitor device, the recipient may require inspection of a portion of the products in the container, and/or may approve all or a portion of the products in the container based on such analyses.

Accordingly, the digital container model and the container monitor device may establish and maintain a digital chain of custody of products loaded into a container that is sufficient to satisfy applicable regulations. In addition, the availability of the digital container model for review by a recipient in parallel with shipment of the container to the recipient may reduce time delays associated with any inspections required upon arrival. Further, the information and data included in the digital container model and the container monitor device may more precisely identify potential exceptions that require inspection, thereby further reducing time delays associated with inspections. Moreover, any exceptions associated with the digital container model or the data from the container monitor device may be provided to other entities, e.g., a sender of the container, to further improve loading and shipping processes, thereby further reducing the number of identified exceptions and associated time delays.

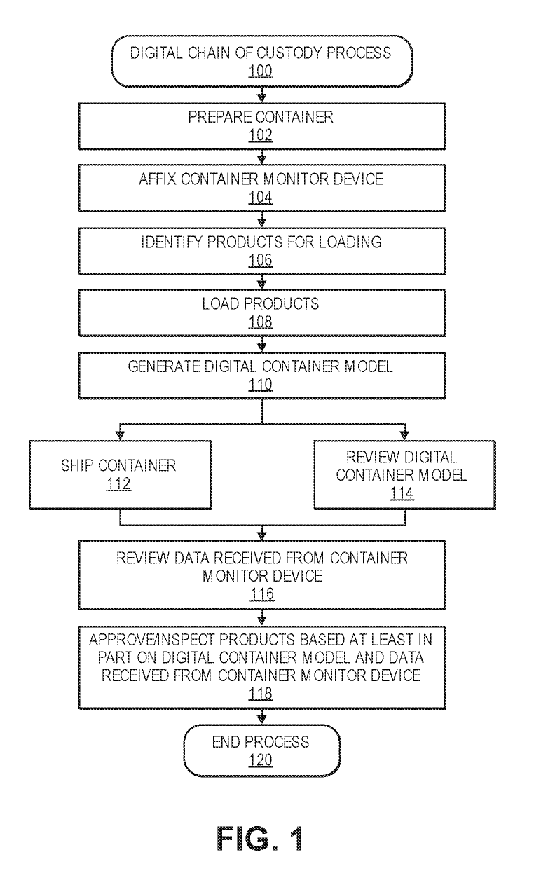

FIG. 1 is a flow diagram illustrating an example digital chain of custody process 100, according to an implementation.

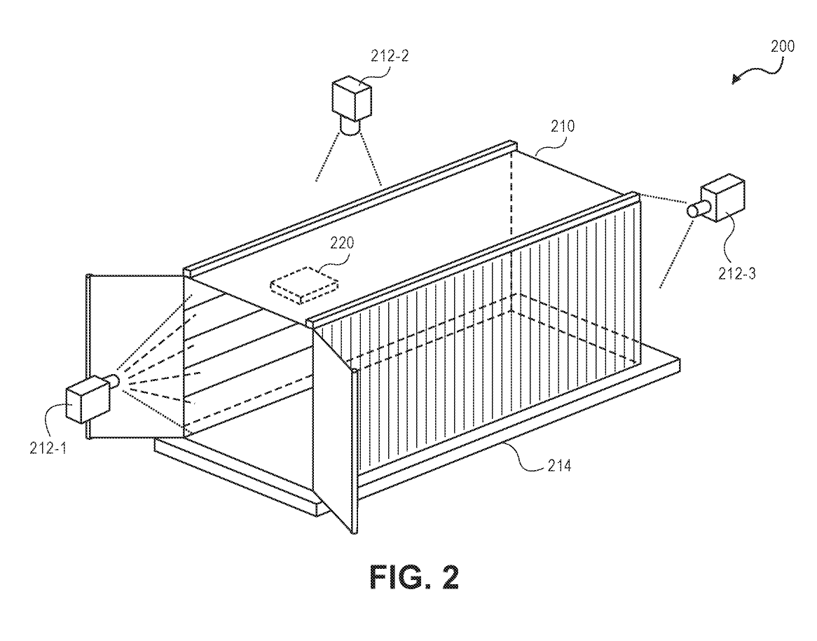

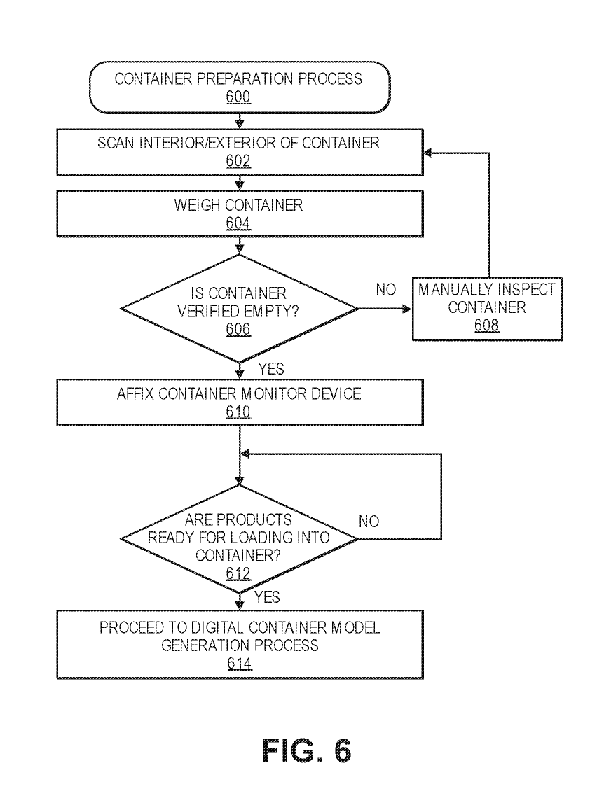

The process 100 may begin by preparing a container for loading and shipping, as at 102. For example, an interior and/or an exterior of the container may be scanned using various devices to determine dimensions. In addition, the interior of the container may be scanned using various devices to verify that it is empty. Further, a weight of the container may also be determined. As a result, a container may be verified as being empty and as having dimensions and weight according to expected specifications. Moreover, once a container is verified, a container monitor device may be affixed within the container, e.g., adjacent an opening of the container, as at 104. Additional details related to preparing a container and attaching a container monitor device within the container are described at least with respect to FIGS. 2 and 6.

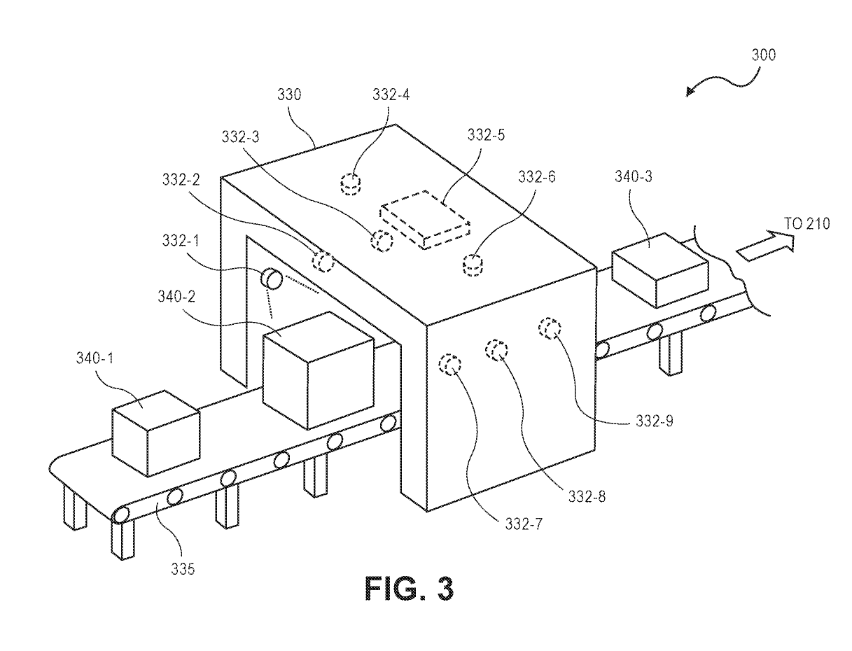

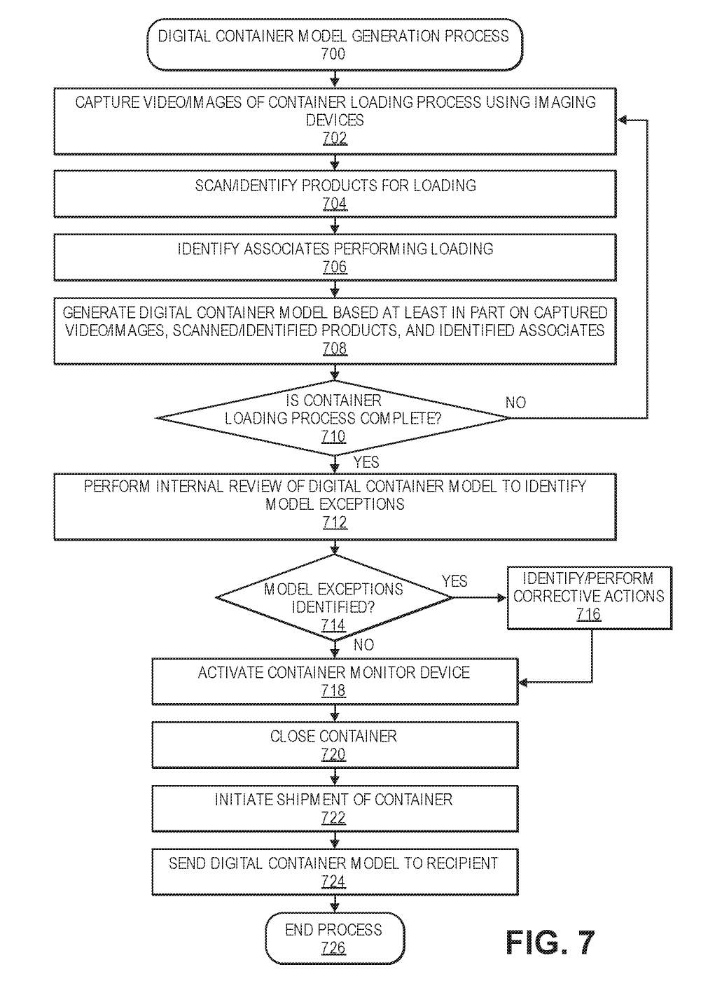

The process 100 may continue by identifying products for loading, as at 106. The products may comprise any type of products, items, or objects, and may be consolidated in pallets, cases, bundles, or other groups. For example, the products may be scanned and/or identified using a sensing tunnel that includes various devices. Barcodes, other identifiers, radiofrequency (RFID) tags or devices, digital signatures of electronic devices, and/or contents of the products may be scanned or identified. In addition, dimensions, volumes, and/or weights of the products may be scanned or identified. Further, video and/or images of products may also be captured. Additional details related to identifying products are described at least with respect to FIGS. 3 and 7.

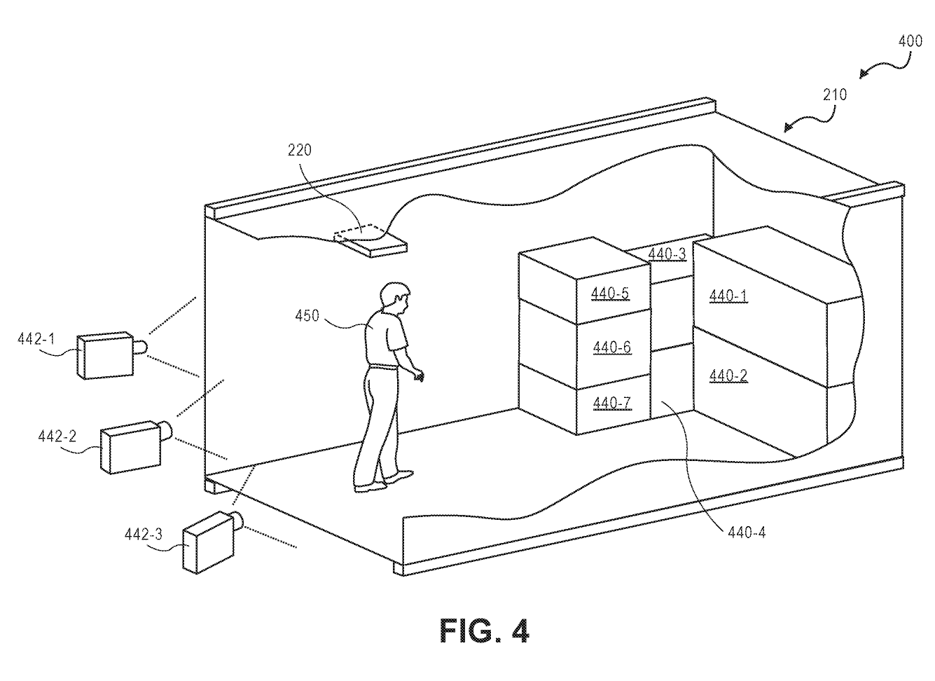

The process 100 may then proceed to load the products into the container, as at 108. For example, the loading may be performed by agents, e.g., human associates, and/or by machines, e.g., robotic devices, robotic arms, gantries, forklifts, cranes, pallet lifts, dollies, or others. During loading of the products into the container, one or more videos and/or images may be captured using various devices. Information associated with the products, locations of the products, and/or information associated with agents and/or machines may be captured within the videos and/or images. Further, upon completion of loading, the container monitor device may be activated, and the container may be closed and/or sealed. Then, the process 100 may continue by generating a digital container model, as at 110. The digital container model may include the videos and/or images captured during loading of the container, as well as information related to the identified products, identified agents, identified machines, and/or other aspects of the loading process. Additional details related to loading products and generating a digital container model are described at least with respect to FIGS. 4 and 7.

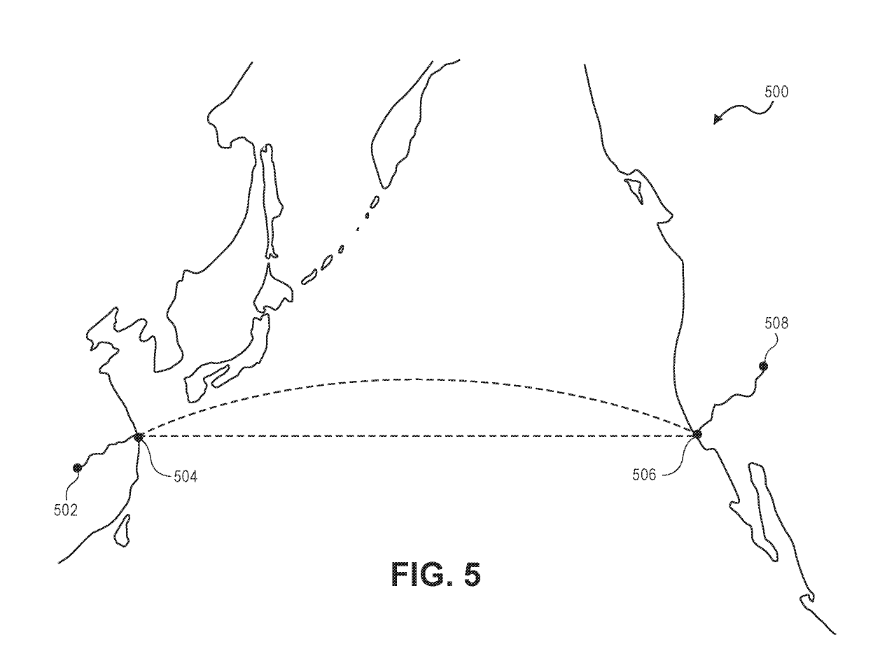

The process 100 may continue by shipping the container to a recipient, as at 112. The recipient may be a customs authority, a receiving entity, a vendor, a distributor, a retailer, a subsidiary or counterpart of a sending entity, or any other entity. For example, the container may be shipped using various transport methods, including air, sea, or land, and combinations thereof. During shipping, the process 100 may also send or otherwise provide the digital container model to the recipient for review and/or analysis, as at 114. For example, the recipient may analyze the digital container model prior to arrival of the container at a location associated with the recipient, in order to identify any exceptions, e.g., model exceptions, associated with products that may require inspection. Additional details related to shipping the container and analyzing the digital container model are described at least with respect to FIGS. 5, 7, and 8.

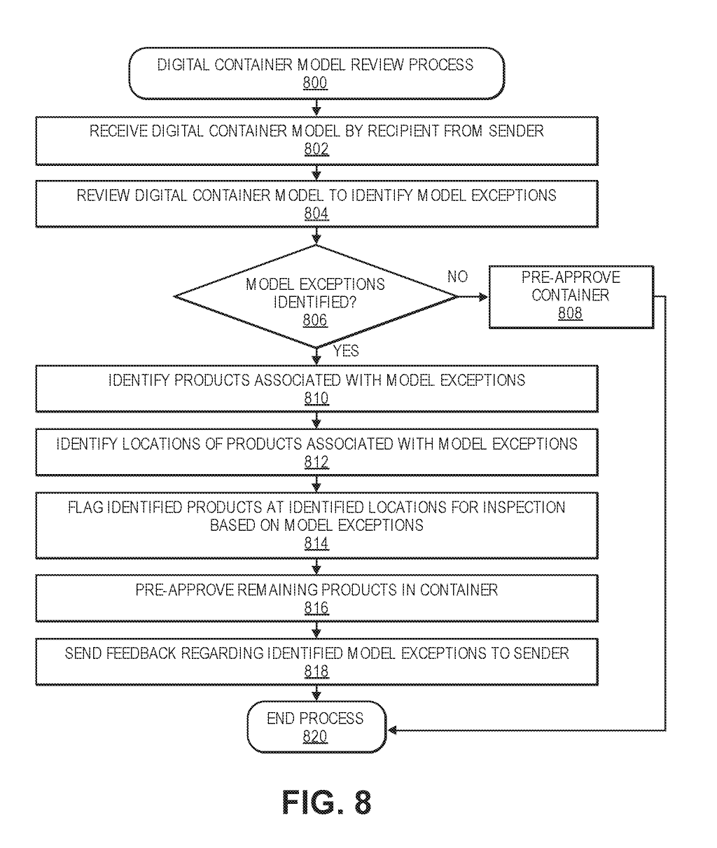

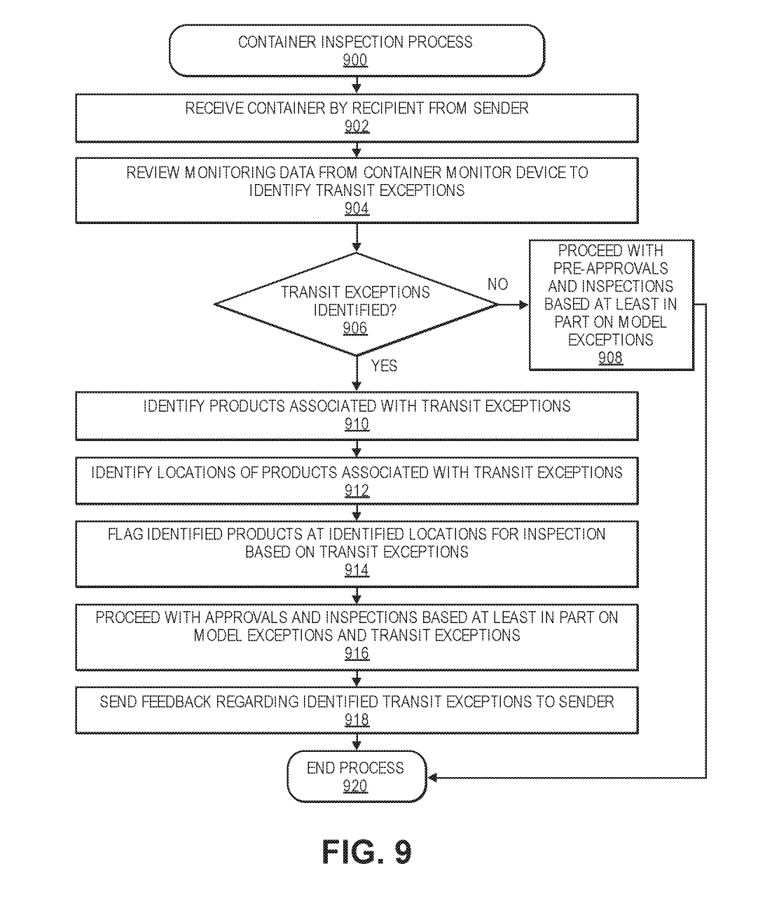

Upon arrival of the container at the location associated with the recipient, the process may then provide data from the container monitor device to the recipient for review and/or analysis, as at 116. For example, the recipient may analyze the data from the container monitor device to identify any exceptions, e.g., transit exceptions, associated with products that may require inspection. The container monitor device may monitor the container using various sensors for any unexpected events during transit, which may include motions during transit, motions within the container, environment changes within the container, and/or breaches or opening of the container. Then, as at 118, based at least in part on the analyses of the digital container model and the data from the container monitor device, all or a portion of the products within the container may undergo inspection, and/or all or a portion of the products within the container may be approved and/or released, e.g., cleared through customs without additional inspection. Additional details related to analyzing the data from the container monitor device and inspecting or approving products within the container are described at least with respect to FIGS. 8 and 9.

FIG. 2 is a schematic diagram of an example container preparation system 200, according to an implementation.

As shown in FIG. 2, a container 210 may be scanned, identified, or otherwise verified using various devices 212. For example, the container 210 may be an intermodal freight or shipping container or any other container within which products may be loaded. In addition, the container 210 may have at least one opening via which products may be loaded and unloaded.

The various devices 212 may include a laser rangefinder, a laser sensor, a radar sensor, a LIDAR sensor, an imaging sensor, an X-ray sensor, a thermal sensor, and/or a radiofrequency identifier (RFID) reader. For example, the various devices 212 may scan, sense, and/or capture images of one or more portions of the exterior and/or the interior of the container. Based on the data captured by the various devices 212, an identity of the container may be determined, e.g., a serial number, barcode, or other identifier of the particular container. In addition, dimensions, size, and/or volume of the container may also be determined, e.g., external dimensions, internal dimensions, available volume, or other dimensional aspects. Further, the detected dimensions, size, and/or volume may be compared with expected dimensions, size, and/or volume of the container to determine whether any modifications have been made to the container. Moreover, any products, items, or other objects present on or within the container may also be identified, either on the exterior or within the interior of the container. Although FIG. 2 shows three devices 212-1, 212-2, 212-3 as part of the container preparation system 200, any other number, combination, and/or arrangement of devices are possible, such as one or more devices 212 within the interior, one or more devices 212 associated with each exterior surface, one or more mobile devices 212, e.g., attached to agents or machines, that perform the scanning, or other combinations and arrangements.

Further, the container preparation system 200 may also include a weight sensor 214. For example, the container may be placed on a weight sensor or scale 214 that may determine the weight of the container. Further, the detected weight may be compared with an expected weight to determine whether any modifications have been made to the container, and/or the detect the presence of any objects that are not visible or detectable on the exterior or within the interior of the container. Although FIG. 2 shows a weight sensor 214 upon which the container 210 is placed, other types or arrangement of weight sensors are also possible, such as a plurality or array of weight sensors upon which the container is placed, a weight sensor or scale from which the container is suspended, or other arrangements.

Based at least in part on the data captured by the various devices 212 and the weight sensor 214, the container 210 may be verified as having expected dimensions, size, volume, and/or weight, and may also be verified as being empty.

Further, a container monitor device 220 may be placed within the identified and verified container 210. For example, the container monitor device 220 may be attached adjacent an opening of the container 210, e.g., on a roof or a sidewall of the container 210. In addition, the container monitor device 220 may be attached by various methods, such as fasteners, adhesives, magnets, suction, or others. Further, the attachment or affixation of the container monitor device 220 within the container 210 may be permanent or removable. Moreover, the container monitor device 220 may be placed within the identified and verified container 210 at any time up to closing and/or sealing the container 210 for shipping.

The container monitor device 220 may include a processor, a local memory storage, a power source, a short-range communication device, a light source, and/or at least one sensor. For example, the at least one sensor may include an accelerometer, a gyroscope, a motion sensor, a proximity sensor, a temperature sensor, a pressure sensor, a humidity sensor, an altimeter, a location sensor, a light sensor, and/or an imaging sensor. In addition, the power source may include a battery or other portable power supply. Further, the short-range communication device may include a transmitter, receiver, and/or transceiver that can communicate with other computing devices at short range, e.g., via Bluetooth, Wi-Fi, LAN, other short-range wireless communication, or direct wired communication. For example, the short-range wireless communication may have a range that is limited to an interior of the container, within a few feet or a few meters of the opening of the container, and/or within a few feet or a few meters of the container monitor device 220.

In some embodiments, the one or more sensors may be collect data continuously and/or periodically during transit to create a digital record that encompasses all or substantially all of the shipping period. In addition, the various sensors that may be included in the container monitor device 220 may detect motions or accelerations of the container as a whole, presence or motions of products, people, or other objects within the container, light or changes of light within the container, changes in environment within the container such as temperature, pressure, and/or humidity, and/or other changes or unexpected events associated with the container or within the interior of the container. Further, one or more sensors may act as triggers for one or more other sensors. For example, a motion or proximity sensor may trigger an imaging sensor and a light source to capture video and/or images within the container for a defined period of time. Likewise, a temperature, pressure, or humidity sensor may also trigger an imaging sensor and a light source to capture video and/or images within the container for a defined period of time. The defined period of time may be thirty seconds, one minute, a few minutes, or longer.

The processor may control the operation of the various sensors, the light source, the power source, and/or the short-range communication device. In addition, the processor may process a portion of the data detected and/or captured by the various sensors, as well as store all data, whether processed or not, within the local memory storage. Further, the detected and/or captured data may be stored with associated timestamps to facilitate review and/or analysis of the data. For example, in some embodiments, the processor may process a portion of the data and apply a flag or otherwise indicate one or more changes or unexpected events within the data for analysis.

Although the example embodiments described herein include a container monitor device including at least one sensor to monitor one or more aspects of the transport process and/or the loading process, the transport process and/or the loading process may be monitored by various systems and methods other than the example embodiments described herein. For example, containers may be physically secured and/or sealed by other methods, such as locks, wraps, seals, or other physical security systems and methods. In addition, containers may be monitored by other methods, such as external security cameras, security personnel, or other monitoring systems and methods. Accordingly, the example embodiments described herein describe particular technical implementations of systems and methods to establish and/or maintain digital chain of custody of products.

FIG. 3 is a schematic diagram of an example product identification system 300, according to an implementation.

As shown in FIG. 3, a sensing tunnel 330 may include various devices 332 to scan and/or identify one or more products 340 to be loaded into an identified and verified container 210. The products 340 may comprise any type of products, items, or objects, and may be consolidated in pallets, cases, bundles, or other groups of various shapes, sizes, and weights. In addition, the products 340 may travel along a conveyor 335 through the sensing tunnel 330. Although FIG. 3 shows three products 340-1, 340-2, 340-3 being transported along the conveyor 335, any other number, combination and/or arrangement of products 340 that are transported by various methods are possible, such as manual placement within the sensing tunnel, transport using forklifts or other lift trucks, or other methods.

The sensing tunnel 330 may include various devices 332, such as a barcode scanner, an imaging sensor, an X-ray sensor, an RFID reader, a digital signature transducer, a thermal sensor, or a weight sensor. For example, the various devices 332 may scan, sense, and/or capture images of barcodes, other identifiers, radiofrequency (RFID) tags or devices, digital signatures of electronic devices, and/or contents of the products. Based on the data captured by the various devices 332, identities of the products may be determined. In addition, dimensions, sizes, volumes, and/or weights of the products may also be determined, e.g., external dimensions, volumes, or other dimensional aspects. Further, the detected data of the products may be compared with expected data of the products to determine whether any products have been misidentified, are counterfeit, or are otherwise inconsistent. Moreover, video and/or images of products may also be captured, and/or two-dimensional or three-dimensional models of the products may be generated based on the sensed or detected data. In addition, the two-dimensional or three-dimensional models of products may also incorporate data sensed or detected by any of the various devices 332, such as X-ray data related to contents, positions, orientations, components, or other information of products within packages, cases, or boxes, and the two-dimensional or three-dimensional models of products may be used in any of the various processes described herein to verify that products loaded into a container match expected data with respect to their dimensions, weights, and/or contents. Although FIG. 3 shows nine devices 332-1, 332-2, 332-3, 332-4, 332-5, 332-6, 332-7, 332-8, 332-9 as part of the sensing tunnel 330, any other number, combination, and/or arrangement of devices are possible, such as one or more devices 332 attached to a sensing tower or column or multiple towers or columns, one or more devices 332 situated under the products or at other orientations, or other combinations and arrangements.

FIG. 4 is a schematic diagram of an example digital container model generation system 400, according to an implementation.

As shown in FIG. 4, after identifying and verifying the container 210, and during and/or after identifying products to be loaded into the container, the identified products 440 may be loaded into the container 210 while one or more imaging devices 442 capture video and/or images of the loading. For example, the imaging devices 442 may include still image capture devices and/or video capture devices, and the imaging devices 442 may operate within any wavelength or frequency of light, e.g., infrared light, visible light, ultraviolet light, or others. Although FIG. 4 shows three imaging devices 442-1, 442-2, 442-3 that capture video and/or images through an opening of the container 210, any other number, combination, and/or arrangement of imaging devices are possible, such as one or more imaging devices 442 located within the interior of the container, one or more imaging devices 442 located by the opening of the container, one or more mobile imaging devices 442, e.g., attached to agents or machines, that perform the loading, or other combinations and arrangements. In addition, although FIG. 4 shows seven products 440-1, 440-2, 440-3, 440-4, 440-5, 440-6, 440-7, e.g., cases of products, that are loaded into the container 210, any other number, combination, and/or arrangement of products are possible, such as different sizes or shapes of products oriented or placed in different positions within the container, or other combinations or arrangements.

The video and/or images captured by the imaging devices 442 may include all or portions of products as they are loaded, e.g., cases, pallets, boxes, or other groups. In addition, the video and/or images may include locations or positions of the products upon loading within the container 210. Further, the video and/or images may include all or portions of agents, e.g., human associates, and/or machines, e.g., robotic devices, robotic arms, gantries, forklifts, cranes, pallet lifts, dollies, or others, that perform the loading such that the agents and/or machines may also be identified. Moreover, the video and/or images may include motions and actions performed by the agents and/or machines while loading the products.

Based at least in part on the captured video and/or images during loading, as well as information associated with the identified products, identified agents, identified machines, and/or other aspects of the loading process, a digital container model may be generated. As described herein, the digital container model may include all the captured video and/or images during loading. In addition, the digital container model may associate information related to products, agents, and/or machines with corresponding portions of the video and/or images in which such products, agents, and/or machines are present. For example, the information related to products may include barcodes, identifiers, RFID information, digital signatures, contents, dimensional information, weight, and/or locations or positions of the loaded products within the container. The information related to agents and/or machines may include identifiers, capabilities, and/or other attributes.

As a result, the digital container model may positively identify aspects of loaded products, locations or positions of loaded products, agents or machines that performed the loading with respect to loaded products, and various other aspects of the loading process, such as time for loading, sequence of loading, methods of loading, motions or actions during loading, and others.

Upon completion of loading of the container 210, the container monitor device 220 may be activated, and the container 210 may be closed and/or sealed. From that point forward, the container monitor device 220 may continuously and/or periodically sense or detect data associated with the container or within the interior of the container using various sensors, and store such data within a local memory storage. In addition, the container monitor device 220 may also sense, detect, or capture data using various sensors in response to one or more triggers, such as motions or accelerations of the container as a whole, presence or motions of products, people, or other objects within the container, light or changes of light within the container, changes in environment within the container such as temperature, pressure, and/or humidity, and/or other changes or unexpected events associated with the container or within the interior of the container.

FIG. 5 is a schematic diagram of an example transport route 500, according to an implementation.

As shown in FIG. 5, a closed, sealed container having products loaded therein may be shipped or transported from point 502 to point 508 via points 504 and 506. The point 502 may be a location of a sender of the container, e.g., a vendor, a manufacturer, a distributor, a wholesaler, a retailer, a sending entity, or any other entity. For example, the container may be loaded with products and closed and/or sealed at point 502, and then transported via truck, rail, bus, or other land transport method to point 504. The path between points 502 and 504 during transit may be associated with particular times, durations, motions, accelerations, elevations, stops, turns, weather, temperatures, pressures, humidity, or other aspects of the transport method and path. For example, land transport between points 502 and 504 may be associated with particular motions, accelerations, stops, and turns on roadways, particular changes in elevation dependent upon the roadway path, particular weather and/or temperatures dependent upon the roadway path, and/or particular times and durations for such land transport.

Point 504 may be a transfer point at which the container is transferred to a different transport method, e.g., air or sea transport, for shipping to point 506. The path between points 504 and 506 during transit may also be associated with particular times, durations, motions, accelerations, elevations, stops, turns, weather, temperatures, pressures, humidity, or other aspects of the transport method and path. For example, air transport between points 504 and 506 may be associated with particular accelerations during takeoff and landing, particular changes in altitude, particular temperatures and/or pressures dependent upon the airborne path, and/or particular times and durations for such air transport. Likewise, sea transport between points 504 and 506 may be associated with particular motions, accelerations, stop, and turns on waterways, particular weather and/or temperatures dependent upon the waterway path, and/or particular times and durations for such sea transport.

Point 506 may be yet another transfer point at which the container is transferred to yet another different transport method, e.g., land transport, for shipping to point 508. The path between points 506 and 508 during transit may also be associated with particular times, durations, motions, accelerations, elevations, stops, turns, weather, temperatures, pressures, humidity, or other aspects of the transport method and path. For example, land transport between points 506 and 508 may be associated with particular motions, accelerations, stops, and turns on roadways, particular changes in elevation dependent upon the roadway path, particular weather and/or temperatures dependent upon the roadway path, and/or particular times and durations for such land transport.

Point 508 may be a location associated with a recipient of the container, e.g., customs authority, a receiving entity, a vendor, a manufacturer, a distributor, a wholesaler, a retailer, a subsidiary or counterpart of a sending entity, or any other entity. For example, point 508 may be a destination location for the products loaded into the container. Upon arrival of the container at the location associated with the recipient, and based at least in part on analyses of the digital container model and data from the container monitor device associated with the container, the recipient may approve one or more products for release from the container without further inspection, and/or the recipient may require inspection of one or more products from the container. Additional details related to analyzing the digital container model, analyzing the data from the container monitor device, and inspecting or approving products within the container are described at least with respect to FIGS. 8 and 9.

Based at least in part on the data from the container monitor device, one or more transit exceptions may be identified that may include any exceptions to the transport process that may result in a need, requirement, or desire to perform an inspection with respect to one or more products loaded in the container. In addition, the transit exceptions that may apply to a particular container may be informed by applicable rules or regulations with respect to shipping products to a particular destination or location, e.g., customs rules of a particular location.

The transit exceptions that may be identified in the data from container monitor devices may relate to motions or accelerations of the container as a whole, presence or motions of products, people, or other objects within the container, light or changes of light within the container, changes in environment within the container such as temperature, pressure, and/or humidity, and/or other changes or unexpected events associated with the container or within the interior of the container.

For example, some transit exceptions may relate to motions or accelerations of the container as a whole. In this regard, transit exceptions may be identified if particular motions, accelerations, stops, turns, changes in elevation, times, durations, or other aspects are different from those that may be expected based on a transport path or method, and/or other aspects related to motions or accelerations of the container as a whole.

In addition, some transit exceptions may relate to presence or motions of products, people, or other objects within the container. In this regard, transit exceptions may be identified if people or objects are detected or moving within the container other than those that may be expected based on the expected contents of the container, and/or other aspects related to presence or motion of products, people, or other objects within the container.

Further, some transit exceptions may relate to light, changes of light, or other changes in environment within the container. In this regard, transit exceptions may be identified if light is detected within the container other than that which may be expected within the container based on a transport path or method, if temperatures are detected within the container other than that which may be expected within the container based on a transport path or method or that may indicate a breach or opening of the container, if pressures are detected within the container other than that which may be expected within the container based on a transport path or method or that may indicate a breach or opening of the container, if humidity is detected within the container other than that which may be expected within the container based on a transport path or method or that may indicate a breach or opening of the container, and/or other aspects related to light, changes of light, or other changes in environment within the container based on a transport path or method.

In some embodiments, computer vision algorithms and/or machine learning algorithms, such as Bayesian networks or models or other machine learning algorithms, may be developed and/or trained to identify transit exceptions within data from container monitor devices. For example, data associated with expected motions or accelerations of the container as a whole, expected presence or motions of products, people, or other objects within the container, expected light or changes of light within the container, expected changes in environment within the container such as temperature, pressure, and/or humidity, and/or other expected changes or events associated with the container or within the interior of the container based at least in part on a transport path or method, and data associated with various transit exceptions based at least in part on a transport path or method may be provided as inputs to a computer vision algorithm and/or a machine learning algorithm to train the algorithms to automatically identify transit exceptions. In addition, as additional data related to expected changes or events and additional data related to transit exceptions identified in data from container monitor devices is obtained, the additional data may be provided as additional inputs to further train and refine the algorithms. The use of such computer vision algorithms and/or machine learning algorithms to identify transit exceptions may further expedite the systems and methods described herein to reduce delays and minimize variations with respect to shipping and inspections.

Although FIG. 5 shows a particular transport route including four points 502, 504, 506, 508 traversed via particular transport methods and paths, any other number, combination, and/or arrangement of points, transfer points, transport methods, and/or transport paths are possible, such as water transport via riverways between points 502 and 504 or between points 506 and 508, air transport between points 502 and 504 or between points 506 and 508, air transport directly between points 502 and 508 or any other points, or other combinations and arrangements.

FIG. 6 is a flow diagram illustrating an example container preparation process 600, according to an implementation.

The process 600 may begin by scanning an interior and/or an exterior of a container, as at 602. For example, the scanning may be performed by various devices, such as a laser rangefinder, a laser sensor, a radar sensor, a LIDAR sensor, an imaging sensor, an X-ray sensor, and/or a radiofrequency identifier (RFID) reader. Then, the process 600 may continue by weighing the container, as at 604. For example, the weighing may be performed by a weight sensor or scale. Based at least in part on data scanned or detected by the various devices, the container may be verified as matching expected specifications of the container. In addition, the container may also be verified as empty based at least in part on the scanned or detected data from the various devices.

The process 600 may then proceed to determine if the container is verified as empty, as at 606. If the container has not been verified as empty, the process 600 may continue to manually inspect the container, as at 608. For example, one or more agents may manually inspect one or more portions of the container using various devices, as described herein, to determine any portions that do not meet expected specifications of the container or to identify any objects present on or within the container. In addition, any objects may be removed from on or within the container. Then, the process 600 may return to scanning and weighing the container, as at 602 and 604, to again attempt to verify the container as matching expected specifications and as being empty. Alternatively, other corrective actions besides manual inspection may be taken to identify portions of a container that do not meet expected specifications or to identify objects that may be present on or within the container.

If the container is verified as empty at 606, then the process 600 may proceed to attach or affix a container monitor device, as at 610. For example, the container monitor device may be placed adjacent an opening of the container, e.g., on a roof or sidewall of the container, via various methods, including fasteners, adhesives, magnets, suction, or others. Then, the process 600 may determine if products are ready for loading into the verified container, as at 612. If not, the process 600 may wait until such time as products are ready for loading. If products are ready for loading into the container, then the process 600 may proceed to the digital container model generation process, as at 614, which is described herein at least with respect to FIG. 7.

FIG. 7 is a flow diagram illustrating an example digital container model generation process 700, according to an implementation.

The process 700 may begin by capturing video and/or images of a container loading process using imaging devices, as at 702. For example, one or more imaging devices may be placed at respective locations inside the container, outside the container, or any other locations. Alternatively, one or more imaging devices may be mobile imaging devices coupled to agents and/or machines that perform the loading, or any other components associated with the loading process. The video and/or images captured by such imaging devices may include information related to products, agents, machines, and/or various aspects of the loading process.

The process 700 may then continue by scanning and identifying products for loading, as at 704. For example, the products may be scanned and detected using a sensing tunnel or other structures, such as sensing towers, columns, surfaces, regions, volumes, or other areas, that include various devices to sense and detect aspects of the products. Identities, contents, dimensions, weights, and/or other aspects of the products may be sensed and detected. In addition, the process 700 may include identifying agents and/or machines that perform one or more portions of the loading process, as at 706. For example, in addition to identities, various actions, motions, and/or other aspects of agents and/or machines may also be sensed and detected.

In example embodiments, the video and/or images captured by imaging devices of the loading process, products, agents, machines, and/or containers may also include digital signatures in order to verify that the video and/or images have not been altered or otherwise modified. For example, for each of the images and/or portions of video streams, the image or portion of the video stream may be processed via an algorithm, e.g., a checksum algorithm or other algorithms that may utilize public and private keys, that creates a digital signature associated with that particular image or portion of the video stream. The digital signature may correspond to a unique identifier associated with the particular image or portion of the video stream. Then, the digital signatures may be stored and/or transmitted for later verification that the video and/or images have not been altered. For example, a recipient of the video and/or images may process each of the images and/or portions of video streams using the same or similar algorithm, and the resulting digital signatures may be compared to the initially stored digital signatures of the video and/or images to verify that no tampering or modification has occurred between capture of the video and/or images by a sending entity and receipt of the video and/or images by a receiving entity.

Then, the process 700 may proceed to generate a digital container model based at least in part on the captured videos and/or images, scanned and identified products, and identified agents and/or machines, as at 708. For example, as part of the digital container model, information related to products may be associated with corresponding portions of the videos and/or images that represent the loading process for such products. In addition, as part of the digital container model, information associated with agents and/or machines may also be associated with corresponding portions of the videos and/or images that represent the loading process performed by such agents or machines. Further, locations or positions of products loaded within the container may also form part of the digital container model. Moreover, times or durations of portions of the loading process, sequences of portions of the loading process, loading methods associated with portions of the loading process, and/or other aspects of portions of the loading process may also form part of the digital container model.

The process 700 may then continue by determining if the container loading process is complete, as at 710. If not, the process 700 may return to capturing video and/or images of the container loading process at 702 with additional products and/or associates identified at 704 and 706.

If the container loading process is determined to be complete at 710, then the process 700 may proceed to perform an internal review of the digital container model to identify model exceptions, as at 712. For example, a sending entity that is preparing the container for transport may perform an internal review of the digital container model before proceeding further with closing, sealing, and/or shipping the container. The model exceptions may include any exceptions to the container loading process that may result in a need, requirement, or desire to perform an inspection with respect to one or more products loaded in the container. In addition, the model exceptions that may apply to a particular container may be informed by applicable rules or regulations with respect to shipping products to a particular destination or location, e.g., customs rules of a particular location.

Further, the internal review may also include a comparison of a shipping manifest or other listing of products intended for loading into the container with the products identified in the digital container model as having been loaded into the container. For example, if a shipping manifest indicates that 100 units of a particular product are intended for loading into the container, but an automated and/or manual review of the digital container model identifies that only 99 units of the particular product have been loaded into the container, such discrepancies or inconsistencies may be identified and corrected during the internal review.

As part of the internal review, the sending entity may determine whether any model exceptions were identified, as at 714, and if yes, the sending entity may identify and/or perform one or more corrective actions, as at 716. For example, the sending entity may capture additional video and/or images that are intended to remedy a model exception. Alternatively or in addition, the sending entity may remove one or more products that may be associated with a model exception. Still further, a corrective action may result in modifications to the container loading process for future shipments without making any changes to a current shipment. Other corrective actions are also possible, such as removing all products from the container, re-loading the products into the container, and re-generating the digital container model, or others.

Further, although FIG. 7 includes an internal review of the digital container model after completion of the container loading process, the internal review may not be performed at all, or the internal review may be performed continuously or periodically during the loading process, such that corrective actions may be identified and/or performed more closely in time with any potential model exceptions identified during the loading process.

The model exceptions that may be identified in the digital container model may relate to products, agents, machines, or any other aspects of the loading process. For example, some model exceptions may relate to positive identification of products loaded into the container. In this regard, model exceptions may be identified if identifying information associated with a product is incomplete, if identifying information associated with a product does not match a corresponding portion of video and/or images during which the product is purportedly loaded, if dimensional information associated with a product does not match a corresponding portion of video and/or images during which the product is purportedly loaded, if a digital signature associated with a product does not match a corresponding portion of video and/or images during which the product is purportedly loaded, if additional or unidentified products are loaded into the container, and/or other aspects related to positive identification of products loaded into the container.

In addition, some model exceptions may relate to positive identification of agents or machines that performed the loading of the container. In this regard, model exceptions may be identified if identifying information associated with an agent or machine is incomplete, if identifying information associated with an agent or machine does not match a corresponding portion of video and/or images during which the agent or machine is purportedly performing loading, if additional or unidentified agents or machines perform loading into the container, and/or other aspects related to positive identification of agents or machines that performed the loading of the container.

Further, some model exceptions may relate to positive identification of portions of the loading process of the container. In this regard, model exceptions may be identified if the loading process of a scanned and/or identified product is missing, if a portion of the loading process for a product is obscured or not visible, if additional or unidentified portions of the loading process are present, and/or other aspects related to positive identification of portions of the loading process of the container.

Moreover, some model exceptions may relate to variations or inconsistencies of portions of the loading process of the container. In this regard, model exceptions may be identified if a portion of the loading process takes a longer amount of time or a shorter amount of time than expected, if a portion of the loading process is performed by a different agent or machine than expected, if a portion of the loading process is performed by a different method than expected, if a portion of the loading process includes an unexpected motion or action of the product, if a portion of the loading process includes an unexpected motion or action of the agent or machine, and/or other aspects related to variations or inconsistencies of portions of the loading process of the container.

In some embodiments, computer vision algorithms and/or machine learning algorithms, such as Bayesian networks or models or other machine learning algorithms, may be developed and/or trained to identify model exceptions within digital container models. For example, data associated with expected products, locations of products, agents, machines, times for loading, sequences of loading, motions or actions during loading, or any other aspects of the loading process, and data associated with various model exceptions may be provided as inputs to a computer vision algorithm and/or a machine learning algorithm to train the algorithms to automatically identify model exceptions. In addition, as additional data related to expected aspects of the loading process and additional data related to model exceptions identified in digital container models is obtained, the additional data may be provided as additional inputs to further train and refine the algorithms. The use of such computer vision algorithms and/or machine learning algorithms to identify model exceptions may further expedite the systems and methods described herein to reduce delays and minimize variations with respect to shipping and inspections.

Continuing with the process 700 of FIG. 7, if no model exceptions were identified at 714, or after identifying and/or performing corrective actions at 716, the process 700 may continue by activating the container monitor device, as at 718. For example, the container monitor device may continuously or periodically detect or sense aspects associated with the container or within the interior of the container using various sensors during transit. In addition, the container monitor device may detect or sense aspects associated with the container or within the interior of the container using various sensors in response to one or more triggers, such as motions or accelerations of the container as a whole, presence or motions of products, people, or other objects within the container, light or changes of light within the container, changes in environment within the container such as temperature, pressure, and/or humidity, and/or other changes or unexpected events associated with the container or within the interior of the container.

In other example embodiments, the container monitor device may be activated prior to or during loading of the products into the container, such that the various sensors of the container monitor device may also detect and sense data associated with products, associates, machines, and/or other aspects of the loading process. For example, data associated with the loading process as monitored by the container monitor device may be later compared with data included in the digital container model as further verification and corroboration that no tampering has occurred with respect to the digital container model, in addition to verifying aspects of the loading process itself.

The process 700 may then proceed to closing and/or sealing the container, as at 720, and initiating shipment of the container, as at 722. The container may be transported by various methods and paths, e.g., by air, sea, or land transport, and various combinations thereof.

Then, the process 700 may send the digital container model to the recipient, as at 724. For example, after generation of the digital container model, and prior to or during shipment of the container, a sending entity may send or otherwise provide the digital container model to the recipient. In addition, various other documentation, e.g., customs clearance forms and documents, may be included as part of the digital container model, or provided together with the digital container model. By providing the digital container model during at least a portion of the transport of the container from the sending entity to the recipient, review and/or analysis of the digital container model may be performed at least partially in parallel with such transport, thereby reducing delays and minimizing variations with respect to shipping and inspections. The process 700 may then end, as at 726.

FIG. 8 is a flow diagram illustrating an example digital container model review process 800, according to an implementation.

The process 800 may begin by receiving a digital container model by a recipient from a sending entity, as at 802. As described herein, the digital container model may be received or otherwise be accessible by the recipient prior to an arrival of the container at a location associated with the recipient, e.g., by a customs authority that will release the container and its products to the recipient. The process 800 may continue by reviewing and/or analyzing the digital container model to identify any model exceptions, as at 804. As described herein, the model exceptions may relate to products, agents, machines, and/or any other aspects of the loading process. Further, as also described herein, computer vision algorithms and/or machine learning algorithms may be developed and/or trained to identify model exceptions within digital container models.

The process 800 may then proceed to determine if any model exceptions have been identified, as at 806. If no model exceptions have been identified at 806, then the process 800 may proceed by pre-approving all products within the container, as at 808. Such pre-approval may permit release of all products within the container, e.g., by a customs authority, to an intended or final recipient without additional inspection of the products.

If, however, one or more model exceptions have been identified at 806, then the process 800 may proceed by identifying products associated with the model exceptions, as at 810, identifying locations of the products associated with the model exceptions, as at 812, and flagging or otherwise indicating identified products at identified locations for inspection based on the model exceptions, as at 814. For example, the products and their locations may be identified based on the videos and/or images of the digital container model. In addition, portions of the videos and/or images of the digital container model that are associated with the model exceptions may also be identified.

In embodiments in which computer vision algorithms and/or machine learning algorithms are used to identify model exceptions, the portions of the videos and/or images and other information associated with the model exceptions may be provided to human inspectors to further analyze and confirm or reject the automatically identified model exceptions. Such combined automated and manual analysis processes may still reduce delays and minimize variations with respect to shipping and inspections by requiring human inspectors only for specific portions of the analysis, instead of relying on human inspectors for all parts of the analysis.

Continuing with the process 800 of FIG. 8, the process 800 may continue by pre-approving remaining products in a container that are not associated with model exceptions, as at 816. For example, by identifying particular products and locations that are associated with model exceptions, additional inspection of such additional products may be more precisely determined, and a remainder of the products in a container may be pre-approved for release without additional inspection, thereby reducing delays and minimizing variations with respect to shipping and inspections.

The process 800 may then proceed to send feedback regarding the identified model exceptions to a sending entity, as at 818. For example, the feedback may enable a sending entity to identify errors and generate corrective actions to its loading processes, digital container model generation processes, or other processes described herein. Further, the feedback may provide additional data that may be provided as additional inputs to further train and refine computer vision algorithms and/or machine learning algorithms that may be used to identify model exceptions, thereby further reducing delays and minimizing variations with respect to shipping and inspections. The process 800 may then end, as at 820.

FIG. 9 is a flow diagram illustrating an example container inspection process 900, according to an implementation.

The process 900 may begin by receiving a container by a recipient from a sending entity, as at 902. As described herein, the container may be received at a location associated with the recipient, e.g., by a customs authority that will release the container and its products to the recipient. The process 900 may continue by reviewing and/or analyzing data from the container monitor device to identify any transit exceptions, as at 904. As described herein, the transit exceptions may relate to motions of the container, presence or motions of objects within the container, light, changes of light, or environment changes within the container, breaches or opening of the container, or any other aspects related to transport of the container. Further, as also described herein, computer vision algorithms and/or machine learning algorithms may be developed and/or trained to identify transit exceptions within data from container monitor devices.

The process 900 may then proceed to determine if any transit exceptions have been identified, as at 906. If no transit exceptions have been identified at 906, then the process 900 may proceed with pre-approvals and inspections as determined based at least in part on any model exceptions identified from the digital container model, as at 908. Such pre-approvals and inspections based on any identified model exceptions may permit release of pre-approved products and/or the completion of inspections, e.g., by a customs authority, with reduced delays after arrival of the container at the location associated with the recipient.

If, however, one or more transit exceptions have been identified at 906, then the process 900 may proceed by identifying products associated with the transit exceptions, as at 910, identifying locations of the products associated with the transit exceptions, as at 912, and flagging or otherwise indicating identified products at identified locations for inspection based on the transit exceptions, as at 914. For example, the products and their locations may be identified based on the videos and/or images of the digital container model and/or the data from the container monitor device. In addition, portions of the videos and/or images from the digital container model and/or the data from the container monitor device that are associated with the transit exceptions may also be identified.

In embodiments in which computer vision algorithms and/or machine learning algorithms are used to identify transit exceptions, the portions of the data from the container monitor device and other information associated with the transit exceptions may be provided to human inspectors to further analyze and confirm or reject the automatically identified transit exceptions. Such combined automated and manual analysis processes may still reduce delays and minimize variations with respect to shipping and inspections by requiring human inspectors only for specific portions of the analysis, instead of relying on human inspectors for all parts of the analysis.

Continuing with the process 900 of FIG. 9, the process 900 may proceed with approvals and inspections of products based at least in part on identified model exceptions from the digital container model and identified transit exceptions from data from the container monitor device, as at 916. For example, by identifying particular products and locations that are associated with model exceptions and transit exceptions, additional inspection of such additional products may be more precisely determined, and a remainder of the products in a container may be approved for release without additional inspection, thereby reducing delays and minimizing variations with respect to shipping and inspections.

The process 900 may then proceed to send feedback regarding the identified transit exceptions to a sending entity, as at 918. For example, the feedback may enable a sending entity to identify errors and generate corrective actions to its loading processes, transport processes, container monitor device processes, digital container model generation processes, or other processes described herein. Further, the feedback may provide additional data that may be provided as additional inputs to further train and refine computer vision algorithms and/or machine learning algorithms that may be used to identify transit exceptions, thereby further reducing delays and minimizing variations with respect to shipping and inspections. The process 900 may then end, as at 920.

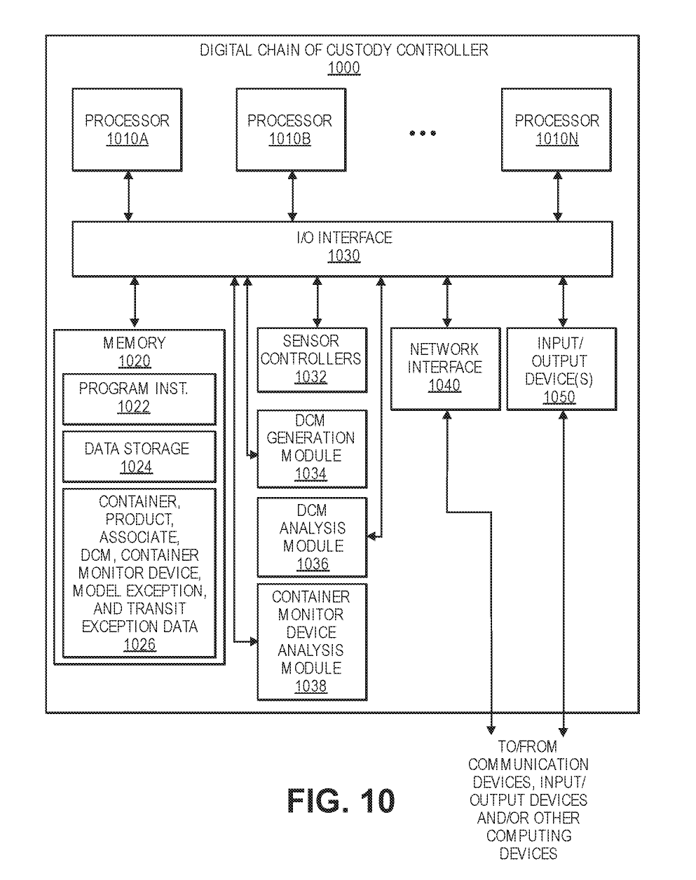

FIG. 10 is a block diagram illustrating various components of a digital chain of custody controller 1000, according to an implementation.

In various examples, the block diagram may be illustrative of one or more aspects of the digital chain of custody controller 1000 that may be used to implement the various systems and processes discussed above. In the illustrated implementation, the digital chain of custody controller 1000 includes one or more processors 1010A-1010N, coupled to a non-transitory computer readable storage medium 1020 via an input/output (I/O) interface 1030. The digital chain of custody controller 1000 may also include sensor controllers 1032, a digital container model (DCM) generation module 1034, a DCM analysis module 1036, and a container monitor device analysis module 1038. The digital chain of custody controller 1000 further includes a network interface 1040, and one or more input/output devices 1050.

In various implementations, the digital chain of custody controller 1000 may be a uniprocessor system including one processor 1010A, or a multiprocessor system including several processors 1010A-1010N (e.g., two, four, eight, or another suitable number). The processor(s) 1010 may be any suitable processor capable of executing instructions. For example, in various implementations, the processor(s) 1010 may be general-purpose or embedded processors implementing any of a variety of instruction set architectures (ISAs), such as the x86, PowerPC, SPARC, or MIPS ISAs, or any other suitable ISA. In multiprocessor systems, each processor(s) 1010 may commonly, but not necessarily, implement the same ISA.

The non-transitory computer readable storage medium 1020 may be configured to store executable instructions, container, product, associate, DCM, container monitor device, model exception, transit exception, sensor, transport path, transport method, and/or environment data, and/or other data items accessible by the processor(s) 1010. In various implementations, the non-transitory computer readable storage medium 1020 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described above, are shown stored within the non-transitory computer readable storage medium 1020 as program instructions 1022, data storage 1024 and container, product, associate, DCM, container monitor device, model exception, and transit exception data 1026, respectively. In other implementations, program instructions, data, and/or container, product, associate, DCM, container monitor device, model exception, transit exception, sensor, transport path, transport method, and/or environment data may be received, sent or stored upon different types of computer-accessible media, such as non-transitory media, or on similar media separate from the non-transitory computer readable storage medium 1020 or the digital chain of custody controller 1000.

Generally speaking, a non-transitory, computer readable storage medium 1020 may include storage media or memory media such as magnetic or optical media, e.g., disk or CD/DVD-ROM, coupled to the digital chain of custody controller 1000 via the I/O interface 1030. Program instructions and data stored via a non-transitory computer readable medium may be transmitted by transmission media or signals, such as electrical, electromagnetic, or digital signals, which may be conveyed via a communication medium such as a network and/or a wireless link, such as may be implemented via the network interface 1040.

In one implementation, the I/O interface 1030 may be configured to coordinate I/O traffic between the processor(s) 1010, the non-transitory computer readable storage medium 1020, and any peripheral devices, the network interface 1040 or other peripheral interfaces, such as input/output devices 1050. In some implementations, the I/O interface 1030 may perform any necessary protocol, timing or other data transformations to convert data signals from one component (e.g., non-transitory computer readable storage medium 1020) into a format suitable for use by another component (e.g., processor(s) 1010). In some implementations, the I/O interface 1030 may include support for devices attached through various types of peripheral buses, such as a variant of the Peripheral Component Interconnect (PCI) bus standard or the Universal Serial Bus (USB) standard, for example. In some implementations, the function of the I/O interface 1030 may be split into two or more separate components, such as a north bridge and a south bridge, for example. Also, in some implementations, some or all of the functionality of the I/O interface 1030, such as an interface to the non-transitory computer readable storage medium 1020, may be incorporated directly into the processor(s) 1010.

The sensor controllers 1032 may communicate with any other components of the digital chain of custody controller 1000 and any of the various devices and sensors 212, 214, 220, 332, 442 described herein in order to detect, sense, capture, or otherwise receive or obtain data from the various devices and sensors. For example, the various devices and sensors may detect, sense, or capture data to identify and verify an empty container, to scan and identify products, to identify agents and/or machines, to capture video and/or images of various aspects of loading processes, and/or to capture data related to transport of containers.

The DCM generation module 1034 may communicate with any other components of the digital chain of custody controller 1000 to generate digital container models based at least in part on data associated with products, agents, machines, and/or various aspects of loading processes. For example, a digital container model may include video and/or images of loading processes, as well as information associated with products loaded into the container and information associated with agents and/or machines who performed the loading.

The DCM analysis module 1036 may include computer vision algorithms and/or machine learning algorithms to analyze digital container models to identify one or more model exceptions. For example, the algorithms may be trained to recognize and identify model exceptions within the digital container models, and may provide such identified model exceptions to human inspectors for additional analysis and confirmation or rejection of such model exceptions. Further, additional training inputs from confirmed model exceptions of digital container models may be provided to the algorithms over time in order to continue to refine and improve such algorithms.

The container monitor device analysis module 1038 may also include computer vision algorithms and/or machine learning algorithms to analyze data from container monitor devices to identify one or more transit exceptions. For example, the algorithms may be trained to recognize and identify transit exceptions within the data from container monitor devices, and may provide such identified transit exceptions to human inspectors for additional analysis and confirmation or rejection of such transit exceptions. Further, additional training inputs from confirmed transit exceptions of data from container monitor devices may be provided to the algorithms over time in order to continue to refine and improve such algorithms.

The network interface 1040 may be configured to allow data to be exchanged between the digital chain of custody controller 1000, other devices attached to a network, such as other computer systems or devices, computer systems or devices associated with sending entities and/or receiving entities, other controllers of components associated with facilities, warehouses, distribution centers, or other environments within which the digital chain of custody controller 1000 may operate, and/or other digital chain of custody controllers of other systems. For example, the network interface 1040 may enable wireless communication between numerous computer systems or devices associated with sending entities and/or receiving entities. In various implementations, the network interface 1040 may support communication via wireless general data networks, such as a Wi-Fi network. For example, the network interface 1040 may support communication via telecommunications networks such as cellular communication networks, satellite networks, and the like.

Input/output devices 1050 may, in some implementations, include one or more displays, audio output devices, image capture devices, microphones, thermal sensors, infrared sensors, accelerometers, pressure sensors, weather sensors, any of the various devices and sensors described herein, etc. Multiple input/output devices 1050 may be present and controlled by the digital chain of custody controller 1000.

As shown in FIG. 10, the memory may include program instructions 1022 which may be configured to implement the example processes and/or sub-processes described above. The data storage 1024 and the container, product, associate, DCM, container monitor device, model exception, and transit exception data 1026 may include various data stores for maintaining data items that may be provided for performing any of the example processes and/or sub-processes described herein, such as generating digital container models, analyzing digital container models, identifying model exceptions, analyzing data from container monitor devices, and/or identifying transit exceptions.

In various implementations, the parameter values and other data illustrated herein as being included in one or more data stores may be combined with other information not described or may be partitioned differently into more, fewer, or different data structures. In some implementations, data stores may be physically located in one memory or may be distributed among two or more memories.

Each process described herein may be implemented by the architectures described herein or by other architectures. The processes are illustrated as a collection of blocks in a logical flow. Some of the blocks represent operations that can be implemented in hardware, software, or a combination thereof. In the context of software, the blocks represent computer-executable instructions stored on one or more computer readable media that, when executed by one or more processors, perform the recited operations. Generally, computer-executable instructions include routines, programs, objects, components, data structures, and the like that perform particular functions or implement particular abstract data types.

The computer readable media may include non-transitory computer readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations, the computer readable media may include a transitory computer readable signal (in compressed or uncompressed form). Examples of computer readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the process. Additionally, one or more of the operations may be considered optional and/or not utilized with other operations.

Those skilled in the art will appreciate that the digital chain of custody controller 1000 is merely illustrative and is not intended to limit the scope of the present disclosure. In particular, the computing system and devices may include any combination of hardware or software that can perform the indicated functions, including computers, network devices, internet appliances, PDAs, wireless phones, pagers, etc. The digital chain of custody controller 1000 may also be connected to other devices that are not illustrated, or instead may operate as a stand-alone system. In addition, the functionality provided by the illustrated components may, in some implementations, be combined in fewer components or distributed in additional components. Similarly, in some implementations, the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated digital chain of custody controller 1000. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from the digital chain of custody controller 1000 may be transmitted to the digital chain of custody controller 1000 via transmission media or signals, such as electrical, electromagnetic, or digital signals, conveyed via a communication medium, such as a network and/or a wireless link. Various implementations may further include receiving, sending or storing instructions and/or data implemented in accordance with the foregoing description upon a computer-accessible medium. Accordingly, the techniques described herein may be practiced with other digital chain of custody controller configurations.

Those skilled in the art will appreciate that, in some implementations, the functionality provided by the processes and systems discussed above may be provided in alternative ways, such as being split among more software modules or routines or consolidated into fewer modules or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that, in other implementations, the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various processes and systems as illustrated in the figures and described herein represent example implementations. The processes and systems may be implemented in software, hardware, or a combination thereof in other implementations. Similarly, the order of any process may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the features recited therein. In addition, while certain aspects are presented below in certain claim forms, the inventors contemplate the various aspects in any available claim form. For example, while only some aspects may currently be recited as being embodied in a computer readable storage medium, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A computer-implemented method to establish chain of custody, comprising:
scanning, using a scanning device, a container to identify at least one of dimensions or contents of the container;
instructing attachment of a container monitor device adjacent an opening of the container;
scanning, via a sensing tunnel, a plurality of products to be loaded into the container;
identifying at least one of dimensions or contents of respective ones of the plurality of products based at least in part on the scanning via the sensing tunnel;
instructing loading of the plurality of products into the container;
capturing, using an imaging device, video data of the loading of the plurality of products by at least one of an agent or a machine;
generating a digital container model of the plurality of products loaded into the container based at least in part on the captured video data and the at least one of the dimensions or the contents of respective ones of the plurality of products;
sending the digital container model to a recipient of the container;
instructing shipment of the container to a location associated with the recipient;
capturing, via the container monitor device, data associated with the container during the shipment; and
responsive to arrival of the container at the location associated with the recipient, determining at least a portion of the plurality of products to inspect based at least in part on an analysis of the digital container model and an analysis of the data associated with the container during the shipment.

2. The computer-implemented method of claim 1, wherein the scanning device comprises at least one of a laser rangefinder, a radar sensor, a LIDAR sensor, an imaging sensor, an X-ray sensor, a thermal sensor, or a radiofrequency identifier (RFID) reader.

3. The computer-implemented method of claim 1, wherein the sensing tunnel comprises at least one of a barcode scanner, an imaging sensor, an X-ray sensor, an RFID reader, a digital signature transducer, a thermal sensor, or a weight sensor.

4. The computer-implemented method of claim 1, wherein the imaging device comprises at least one of a still image capture device or a video capture device.

5. The computer-implemented method of claim 1, wherein the container monitor device comprises a processor, a local memory storage, a power source, a short-range communication device, a light source, and at least one sensor; and
wherein the at least one sensor comprises at least one of an accelerometer, a gyroscope, a motion sensor, a proximity sensor, a temperature sensor, a pressure sensor, a humidity sensor, an altimeter, a light sensor, or an imaging sensor.

6. A computer-implemented method, comprising:
identifying at least one of dimensions or contents of a container;
instructing attachment of a container monitor device within the container;
identifying at least one of dimensions or contents of a plurality of products to be loaded into the container;
capturing, using an imaging device, at least one image during loading of the plurality of products into the container;
generating a digital container model of the plurality of products loaded into the container based at least in part on the captured at least one image and the at least one of the dimensions or the contents of the plurality of products;
providing the digital container model to a recipient of the container prior to or during shipment;
capturing, via the container monitor device, data associated with the container during shipment to a location associated with the recipient; and
responsive to arrival of the container at the location associated with the recipient, providing the data associated with the container during shipment to the recipient.

7. The computer-implemented method of claim 6, wherein identifying the at least one of the dimensions or the contents of the container further comprises:
detecting the at least one of the dimensions or the contents of the container using at least one of a laser rangefinder, a radar sensor, a LIDAR sensor, an imaging sensor, an X-ray sensor, a radiofrequency identifier (RFID) reader, a thermal sensor, or a weight sensor; and
determining that the container is empty based at least in part on the at least one of the dimensions or the contents of the container.

8. The computer-implemented method of claim 6, wherein instructing the attachment of the container monitor device within the container further comprises:
instructing the attachment of the container monitor device to at least one of a roof or a sidewall adjacent an opening of the container using at least one of a magnetic attachment, a suction attachment, a fastener, or an adhesive.

9. The computer-implemented method of claim 6, wherein identifying the at least one of the dimensions or the contents of the plurality of products to be loaded into the container further comprises:
detecting the at least one of the dimensions or the contents of the plurality of products using at least one of a barcode scanner, an imaging sensor, an X-ray sensor, an RFID reader, a digital signature transducer, a thermal sensor, or a weight sensor.

10. The computer-implemented method of claim 6, wherein capturing, using the imaging device, the at least one image during loading of the plurality of products into the container further comprises:
capturing a plurality of images during loading of respective ones of the plurality of products by at least one of an agent or a machine, the plurality of images including respective positions of the respective ones of the plurality of products within the container; and
detecting an identity of the at least one of the agent or the machine using at least one of an imaging sensor, an RFID reader, or a barcode scanner.

11. The computer-implemented method of claim 10, wherein the digital container model comprises at least one of the dimensions or the contents of the plurality of products, respective positions of the respective ones of the plurality of products within the container, the identity of the at least one of the agent or the machine, barcode information associated with the respective ones of the plurality of products, RFID data associated with the respective ones of the plurality of products, or digital signatures associated with the respective ones of the plurality of products.

12. The computer-implemented method of claim 6, wherein providing the digital container model to the recipient of the container prior to or during shipment further comprises:
generating customs clearance information associated with the plurality of products loaded into the container based at least in part on the captured at least one image and the at least one of the dimensions or the contents of the plurality of products; and
providing, with the digital container model, the customs clearance information to the recipient of the container prior to or during shipment.

13. The computer-implemented method of claim 6, wherein capturing, via the container monitor device, the data associated with the container during shipment further comprises:
detecting a change associated the container during shipment, the change related to at least one of acceleration, motion, temperature, pressure, humidity, altitude, light, an opening of the container, or an object in proximity; and
storing information associated with the detected change within a local memory storage of the container monitor device;
wherein the change is detected using at least one of an accelerometer, a gyroscope, a motion sensor, a proximity sensor, a temperature sensor, a pressure sensor, a humidity sensor, an altimeter, a light sensor, or an imaging sensor.

14. The computer-implemented method of claim 13, wherein capturing, via the container monitor device, the data associated with the container during shipment further comprises:
triggering the imaging sensor for a defined period of time based at least in part on the detected change;
capturing, via the imaging sensor of the container monitor device, video data within the container for the defined period of time; and
storing the captured video data as part of the information associated with the detected change within the local memory storage of the container monitor device.

15. The computer-implemented method of claim 14, wherein providing the data associated with the container during shipment to the recipient further comprises:
providing at least the information associated with the detected change from the local memory storage via a short-range communication device of the container monitor device to a computing device associated with the recipient.

16. A non-transitory, computer-readable medium comprising executable instructions thereon, which, when executed by a processor, cause the processor to at least:
receive a digital container model of a plurality of products loaded into a container, the digital container model including at least one image captured during loading of the plurality of products into the container and at least one of dimensions or contents of the plurality of products;
analyze the digital container model to determine at least one model exception related to a first product of the plurality of products;
responsive to receipt of the container, receive, via a container monitor device within the container, data associated with the container during shipment;
analyze the data associated with the container during shipment to determine at least one transit exception related to a second product of the plurality of products; and
instruct inspection of the first product based at least in part on the at least one model exception and inspection of the second product based at least in part on the at least one transit exception.

17. The non-transitory, computer-readable medium of claim 16, wherein the at least one model exception related to the first product comprises at least one of:
a difference between the at least one of the dimensions or the contents of the first product and actual dimensions or actual contents of the first product within the at least one image captured during loading of the first product;
a difference between agent information associated with loading of the first product and an actual agent within the at least one image captured during loading of the first product;
an obfuscation of at least a portion of the first product within the at least one image; or
a difference between an expected loading process for the first product and an actual loading process within the at least one image captured during loading of the first product.

18. The non-transitory, computer-readable medium of claim 16, wherein the at least one transit exception related to the second product comprises at least one of:
a difference between an expected motion of the container and an actual motion of the container during shipment;
a change in at least one of temperature, pressure, humidity, or light within the container during shipment;
a motion within the container during shipment; or
a breach of an opening of the container during shipment.

19. The non-transitory, computer-readable medium of claim 16, wherein the executable instructions further cause the processor to at least:
provide, to a sender of the digital container model and the container, information associated with at least one of the at least one model exception or the at least one transit exception.

20. The non-transitory, computer-readable medium of claim 16, wherein the executable instructions further cause the processor to at least:
instruct release of a remainder of the plurality of products loaded into the container that are not associated with at least one model exception or at least one transit exception.
